(19) United States
(12) Patent Application Publication
(10) Pub. No.: US 2009/0063623 A1
(43) Pub. Date: Mar. 5, 2009

(54) DETERMINING CONNECTION INFORMATION TO USE TO ACCESS AN ARTIFACT FROM AN APPLICATION ON A REMOTE SERVER

(75) Inventors: Michael Wayne BROWN, Georgetown, TX (US); Gang CHEN, Beijing (CN); Hua CHENG, Beijing (CN); Christopher Shane CLAUSSEN, Austin, TX (US); Xin HUANG, Beijing (CN); Xiaochun MEI, Palo Alto, CA (US); Charles James REDLIN, Rochester, MN (US); Hai Yun ZHAO, Beijing (CN)

Correspondence Address: KONRAD RAYNES & VICTOR, LLP;ATTN: IBM54, 315 SOUTH BEVERLY DRIVE, SUITE 210, BEVERLY HILLS, CA, 90212, US

(73) Assignee: INTERNATIONAL BUSINESS MACHINES CORPORATION, Armonk, NY (US)

(21) Appl. No.: 11/849,207

(22) Filed: Aug. 31, 2007

(51) Int. Cl. G06F 15/16

(52) U.S. Cl. 709/203

(57) ABSTRACT

Provided are a method, system, and article of manufacture for determining connection information to use to access an artifact from an application on a remote server. A request is received in a local server for an artifact at a target application executing on a remote server. A determination is made as to whether a local repository includes connection information on the remote server. The connection information is used to communicate the request for the artifact to the remote server over a network. The connection information is accessed from the local repository in response to determining that the local repository includes the connection information for the remote server. A determination is made as to whether a common repository is available to provide the connection information for the remote server in response to determining that the local repository does not include the connection information for the remote server. Communication is made to the common repository over the network to access the connection information for the remote server in response to determining that the common repository is available to provide the connection information.

### BACKGROUND OF THE INVENTION

1. Field of the Invention

The present invention relates to a method, system, and article of manufacture for determining connection information to use to access an artifact from an application on a remote server.

2. Description of the Related Art

To communicate requests for an artifact to a target application on a remote server in a network environment, a client application needs to determine connection information on the location of the server including the target application, such as a communication protocol, network address and port on which to transmit the request. If the connection information changes, then a user must reconfigure the connection parameters for the server including the target application with new connection information.

The Java Naming and Directory Interface (JNDI) provides an application programming interface (API) for a directory service that allows clients to discover and lookup data and objects via a name, and use that information to communicate with the named object. However, if the connection information for the servers that include the objects changes, then the user needs to update the connection information for those servers that are communicating using a different network address, port and/or communication protocol.

There is a need in the art for improved techniques for determining and using connection information to communicate artifact requests to applications in a distributed computing environment.

### SUMMARY

Provided are a method, system, and article of manufacture for determining connection information to use to access an artifact from an application on a remote server. A request is received in a local server for an artifact at a target application executing on a remote server. A determination is made as to whether a local repository includes connection information on the remote server. The connection information is used to communicate the request for the artifact to the remote server over a network. The connection information is accessed from the local repository in response to determining that the local repository includes the connection information for the remote server. A determination is made as to whether a common repository is available to provide the connection information for the remote server in response to determining that the local repository does not include the connection information for the remote server. Communication is made to the common repository over the network to access the connection information for the remote server in response to determining that the common repository is available to provide the connection information.

### BRIEF DESCRIPTION OF THE DRAWINGS

FIG. 1 illustrates an embodiment of a network computing environment.

FIG. 2 illustrates an embodiment of a repository entry.

FIG. 3 illustrates an embodiment of an artifact request.

FIG. 4 illustrates an embodiment of operations to update an entry in a repository.

FIG. 5 illustrates an embodiment of operations to communicate an artifact request to a remote server.

FIG. 6 illustrates an embodiment of operations to process an artifact request.

FIG. 7 illustrates an embodiment of an architecture that may be used with the described embodiments.

### DETAILED DESCRIPTION

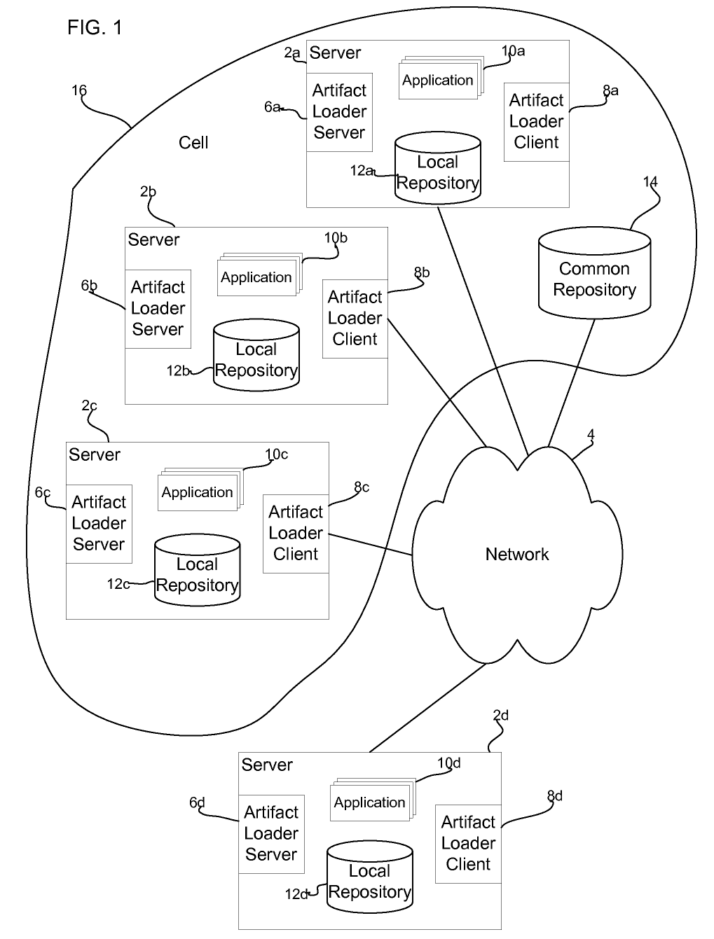

FIG. 1 illustrates an embodiment of a computing environment. A plurality of servers 2a, 2b, 2c, 2d communicate over a network 4 and each include an artifact loader server 6a, 6b, 6c, 6d component, an artifact loader client 8a, 8b, 8c, 8d component, one or more applications 10a, 10b, 10c, 10d, and a local repository 12a, 12b, 12c, 12d. A common repository 14 provides connection information for applications 10a, 10b, 10c that are designated as grouped in a cell 16. The common repository 14 broadcasts connection information added to the common repository 14 on applications 10a, 10b, 10c designated in the cell 16 to the servers 2a, 2b, 2c designated in the cell 16. The servers 2a, 2b, 2c receiving updated connection information for applications 10a, 10b, 10c in the cell 16 may apply the updates to their local repository 12a, 12b, 12c.

A cell 16 provides a grouping of servers 12a, 12b, 12c that are registered with the common repository 14 to share connection information for the applications 10a, 10b, 10c running in the servers 12a, 12b, 12c grouped in the cell 16. Thus, the local repositories 12a, 12b, 12c in the servers 2a, 2b, 2c in the cell 16 share connection information for the registered applications 10a, 10b, 10c in the cell. The local repository 12 for the server 2d that is not grouped in the cell 16 may not receive connection information maintained in the common repository 14.

The network 4 may comprise a network, such as a Local Area Network (LAN), Storage Area Network (SAN), Wide Area Network (WAN), wireless network, etc. The network may implement one or more network types. The repositories 12a, 12b, 12c, 12d and 14 may include processing and communication capabilities as well as persistent storage implemented in storage or memory, such as magnetic storage media (e.g., hard disk drives), Flash Memory, etc. The common repository 14 may be implemented in one server 2a, 2b, 2c in the cell 16 or in a separate system.

Although four servers and one cell are shown in FIG. 1, in different implementations the network computing environment may include any number of servers, applications in each server, cells having a common repository, etc.

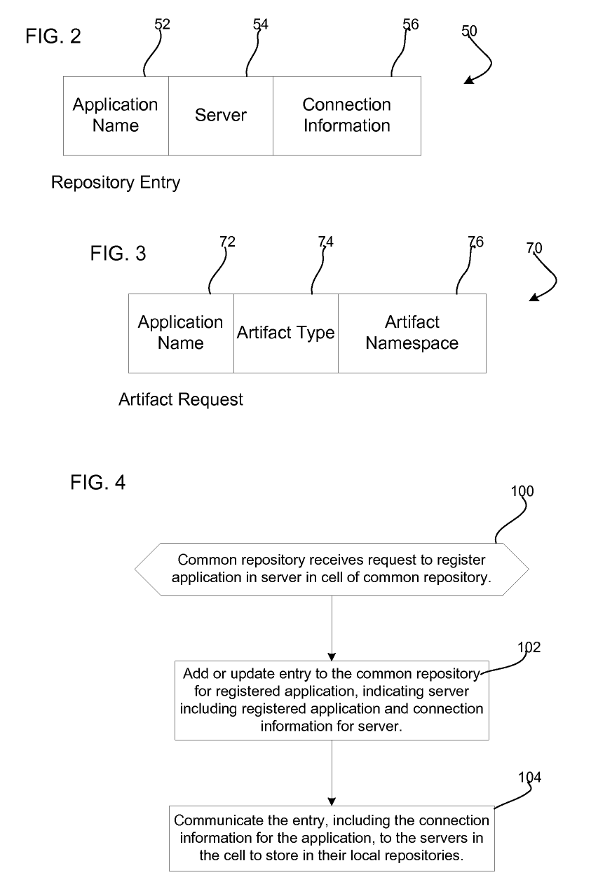

FIG.2 illustrates an embodiment of an entry 50 maintained in the common 14 and local 12a, 12b, 12c, 12d repositories, including an application name 52 of the application 10a, 10b, 10c in the cell 16 that registered with the common repository 14, a server 54 in which the application 52 runs, and connection information 56 that may be used to communicate with the server. The connection information 56 may include a network address, such as an Internet Protocol (IP) address, a port that may be used to communicate artifact loader related requests, and a communication or network protocol. In one embodiment, the port indicated in the connection information 56 may comprise the port of a remote artifact loader server 6a, 6b, 6c, 6d to which the artifact loader client 8a, 8b, 8c, 8d, 8d directs artifact related requests.

FIG. 3 illustrates an embodiment of an artifact request 70 the artifact loader client 8a, 8b, 8c, 8d may communicate to an artifact loader server 6a, 6b, 6c, 6d, including an application name 72 that generates and provides the artifact, an artifact type 74, and a unique artifact namespace 76. The artifact may comprise an object, file, document, multimedia file, database record or table, etc. In one embodiment, the application 10a, 10b, 10c, 10d may communicate a request for an artifact in an application format that differs from the format of the artifact request 70 the artifact loader client 8a, 8b, 8c, 8d receiving the application request sends to an artifact loader server 6a, 6b, 6c, 6d. An artifact can be identified by a target namespace (TNS). A namespace may comprise an abstract container providing context for the items, such as artifacts, it holds and allows disambiguation of items having the same name (residing in different namespaces, e.g., URL). For example, as a rule, names in a namespace cannot have more than one meaning, that is, two or more things cannot share the same name. A namespace is also called a context, as the valid meaning of a name can change depending on what namespace applies

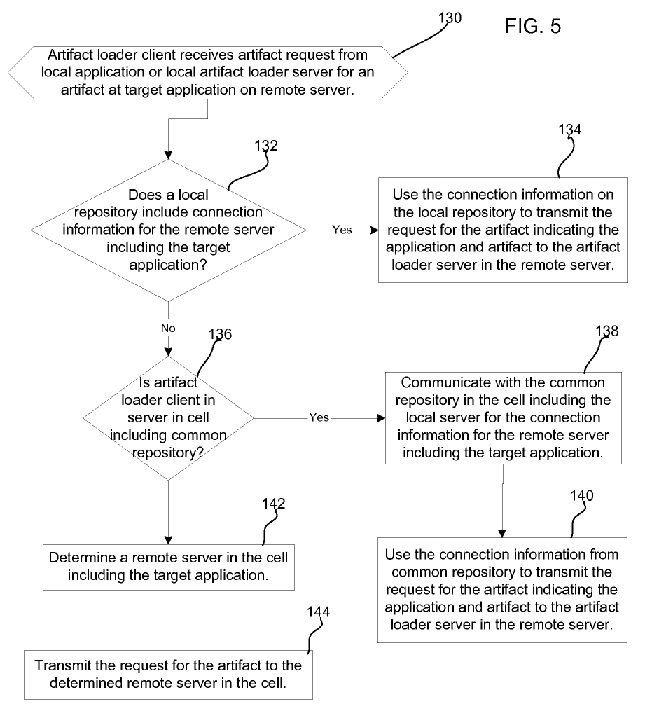

FIG. 4 illustrates an embodiment of operations performed by code or software executed by a processor or logic executed by hardware in the common repository 14 to register information on an application 10a, 10b, 10c in the cell 16. Upon receiving (at block 100) a request to register an application 10a, 10b, 10c or update connection information for the server 2a, 2b, 2c including the registering application 10a, 10b, 10c in the cell 16 of the common repository 14, the common repository 14 adds or updates (at block 102) an entry 50 in the common repository 14 for the registering application 10a, 10b, 10c indicating the server 54 including the registered application 52 and connection information 56 for the server 54. The application 10a, 10b, 10c may update the common repository 14 with information on a new application added to one sever 2a, 2b, 2c, an update to the connection information 56 in an entry 50 for an existing registered application or an additional server including an application. The common repository 14 may communicate (at block 104) the added or updated entry, including the connection information for the application 10a, 10b, 10c, two-way to the servers 2a, 2b, 2c in the cell 16 to store in their local repositories 12a, 12b, 12c. The common repository 14 may further broadcast a command to delete a repository entry 50 that is replaced or removed.

FIG. 5 illustrates an embodiment of operations performed by an artifact loader client 8a, 8b, 8c, 8d to process a request for an artifact at a target application 10a, 10b, 10c, which is remote with respect to the server 2a, 2b, 2c, 2d including the artifact loader client 8a, 8b, 8c, 8d receiving the request. The request may be originated from an application 10a, 10b, 10c, 10d local to the server 2a, 2b, 2c,2d including the artifact loader client 8a, 8b, 8c, 8d or may be received from an artifact loader server 6a, 6b, 6c, 6d local to the server including the artifact loader client 8a, 8b, 8c, 8d. Upon receiving (at block 130) the artifact request for an artifact at a target application in a remote server, the artifact loader client 8a, 8b, 8c, 8d determines (at block 132) whether the local repository 12a, 12b, 12c, 12d includes an entry 50 (FIG. 2) for the target application with connection information 56 for the remote server 54 including the target application 52. If (at block 132) there is an entry 50 in the local repository 12a, 12b, 12c, 12d, then the artifact loader client 8a, 8b, 8c uses (at block 134) the connection information 56 in entry 50 in the local repository 12a, 12b, 12c, 12d to transmit the artifact request 50 (FIG. 2) indicating the application 72 and artifact namespace 76 to the artifact loader server 6a, 6b, 6c a at the network address and port indicated in the determined connection information 56.

If (at block 132) the local repository 12a, 12b, 12c, 12d does not include an entry 50 for the application 10a, 10b, 10c, 10d providing the requested artifact and if (at block 136) the artifact loader client 8a, 8b, 8c is in a server 2a, 2b, 2c in the cell 16 including the common repository 14, then the artifact loader client 8a, 8b, 8c communicates (at block 138) with the common repository 14 in the cell 16 in which the artifact loader client is located, if one is available, such as if the artifact loader client 8a, 8b, 8c is in the cell 16, to obtain the connection information 56 for the remote server including the target application 10a, 10b, 10c. The artifact loader client 8a, 8b, 8c uses (at block 140) the connection information from the common repository 14 to transmit the request for the artifact indicating the application and artifact to the artifact loader server 6a, 6b, 6c in the remote server 2a, 2b, 2c, e.g., communicates the request to the port and network address indicated in the connection information. The artifact loader client 8a, 8b, 8c may further update the local repository 12a, 12b, 12c with the connection information provided from the common repository 14.

If (at block 136) the artifact loader client 8d is not in the cell 16 including the common repository 14, then the artifact loader client 8d determines (at block 142) a remote server 2a, 2b, 2c in the cell 16 including the target application 10a, 10b, 10c and transmits (at block 144) the request 70 (FIG. 3) for the artifact to the determined remote server 2a, 2b, 2c in the cell 16.

In one embodiment, the common repository 14 may only be available to provide updated connection information not found in the local repository 12a, 12b, 12c if the local server 2a, 2b, 2c including the artifact loader client 8a, 8b, 8c trying to obtain the connection information 56 is in the same cell 16 including the remote server including the target application having the artifact. In one embodiment, the artifact loader client 8d may transmit the artifact request to a remote server 2a, 2b, 2c in the cell 16 in which the artifact loader client 8d is not included.

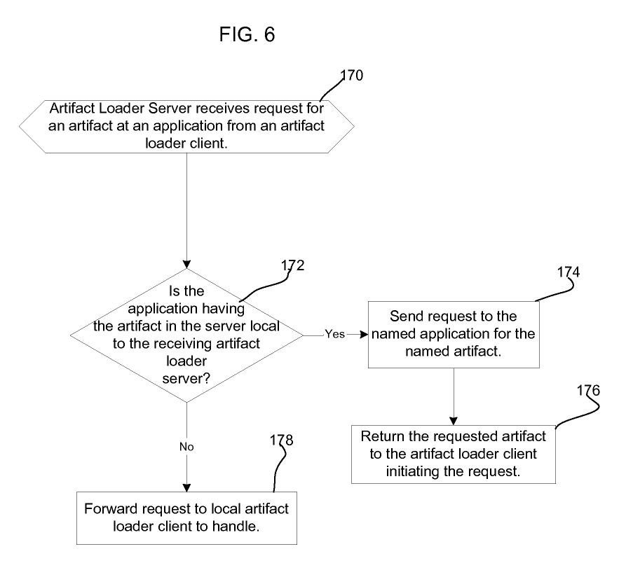

FIG. 6 illustrates an embodiment of operations performed by the artifact loader server 6a, 6b, 6c, 6d upon receiving an artifact request 70 (FIG. 3) from an artifact loader client 8c, which may be communicated on the port used by the artifact loader server 6a, 6b, 6c, 6d. In response to receiving (at block 170) a request for an artifact from a local or remote artifact loader client 8a, 8b, 8c, 8d, the artifact loader sever 6a, 6b, 6c, 6d determines (at block 172) whether the named application 52 in the request 70 is in the server 2a, 2b, 2c, 2d local to the artifact loader server 6a, 6b, 6c, 6d receiving the request. If so, then the artifact loader server 6a, 6b, 6c, 6d sends (at block 174) a request to the named application for the named artifact and returns (at block 176) the requested artifact to the artifact loader client 8a, 8b, 8c, 8d initiating the request to the artifact loader server 6a, 6b, 6c, 6d. The artifact loader client 8a, 8b, 8c, 8d initiating the request may comprise a remote artifact loader client 8a, 8b, 8c, 8d on another server 2a, 2b, 2c, 2d or on the server local to the artifact loader server 6a, 6b, 6c, 6d performing the operations. If (at block 172) the named application 72 (FIG. 3) in the request 70 is not local in the server in which the artifact loader server 6a, 6b, 6c, 6d processing the request runs, then the artifact loader server 6a, 6b, 6c, 6d forwards (at block 178) the artifact request 70 to the local artifact loader client 8a, 8b, 8c, 8d in the server 2a, 2b, 2c, d. The artifact loader client 8a, 8b, 8c, 8d may then perform the operations in FIG. 5 to determine how to process the request.

In certain embodiments, a named application 72 in an artifact request 70 may be located on multiple servers 2a, 2b, 2c in the cell 16. In such case, the artifact loader client 8a, 8b, 8c may utilize load balancing techniques to select one of the servers 2a, 2b, 2c having the application 10, 10b, 10c. For instance, the artifact loader client 8a, 8b, 8c may query the servers having the named application or otherwise obtain information on the current processing load at the servers 2a, 2b, 2c having the named application 72 to select one server 2a, 2b, 2c to which to direct the request that has the least processing load. Alternatively, the artifact loader client 8a, 8b, 8c may use a round robin or other selection technique to alternate selection of the one of the multiple servers 2a, 2b, 2c having a named application so that multiple artifact requests to the same application 10a, 10b, 10c are distributed among the servers 2a, 2b, 2c having the target application 10a, 10b, 10c.

Described embodiments provide techniques to locate a server in a network environment including an application having an artifact needed on another server in the network. In the described embodiments, the operations to locate and send artifact requests to applications in different servers are handled by an artifact loader client and server components running on every participating server.

Further, the described embodiments provide an application name based programming model, such that when an application 10a, 10b, 10c, 10d needs to load artifacts from a target application, the requesting application does not need to provide the location of the server 2a, 2b, 2c, 2d on which the target application is installed. Instead, the requesting application need only provide the name of the application having the requested artifact and the artifact loader client and server will handle selection and routing to the server including the target application capable of providing the requested artifact.

### Additional Embodiment Details

The described operations may be implemented as a method, apparatus or article of manufacture using standard programming and/or engineering techniques to produce software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

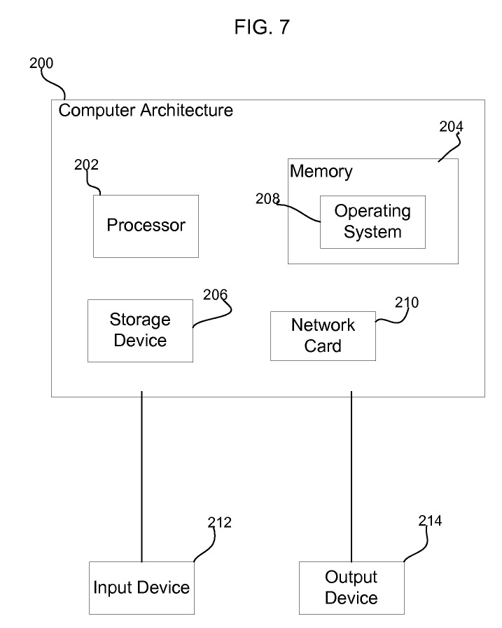

FIG. 7 illustrates an embodiment of a computer architecture 200 that may be implemented in the servers 2a, 2b, 2c, 2d and common repository 14 of FIG. 1. The architecture 200 may include a processor 202 (e.g., a microprocessor), a memory 204 (e.g., a volatile memory device), and storage 206 (e.g., a non-volatile storage, such as magnetic disk drives, optical disk drives, a tape drive, etc.). The storage 206 may comprise an internal storage device or an attached or network accessible storage. Programs, including an operating system 208, device drivers and application programs, in the storage 206 are loaded into the memory 204 and executed by the processor 202 in a manner known in the art. The architecture further includes a network card 210 to enable communication with a network. An input device 212 is used to provide user input to the processor 212, and may include a keyboard, mouse, pen-stylus, microphone, touch sensitive display screen, or any other activation or input mechanism known in the art. An output device 214 is capable of rendering information transmitted from the processor 212, or other component, such as a display monitor, printer, storage, etc.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of FIGS. 4, 5, and 6 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An article of manufacture including code executed in servers in a network, wherein a common repository is coupled to the network, wherein the code causes operations to be performed, the operations, comprising:
receiving a request for an artifact at a target application executing on a remote server comprising one of the servers in the network;
determining whether a local repository includes connection information on the remote server, wherein the connection information is used to communicate the request for the artifact to the remote server over the network;
accessing the connection information from the local repository in response to determining that the local repository includes the connection information for the remote server;
determining whether a common repository is available to provide the connection information for the remote server in response to determining that the local repository does not include the connection information for the remote server; and
communicating with the common repository over the network to access the connection information for the remote server in response to determining that the common repository is available to provide the connection information.

2. The article of manufacture of claim 1, wherein the request includes a name of the target application, a type of the requested artifact, and a name of the requested artifact, and wherein the connection information indicates a network address and a port to use to communicate with the remote server.

3. The article of manufacture of claim 1, wherein the code when executing in servers designated in a cell further perform operations comprising:
receiving, from the common repository, connection information on applications in the servers designated in a cell; and
storing the connection information for applications on the servers in the cell in the local repository.

4. The article of manufacture of claim 1, wherein the common repository is available to provide the connection information if the remote server is designated in a cell including the common repository and the remote server including the target application.

5. The article of manufacture of claim 4, wherein the code when executing in servers not in the cell including the remote server and the common repository, further performs operations comprising:
transmitting the request for the artifact to a determined remote server in the cell including the remote server including the target application in response to determining that the remote server is not in the cell including the remote server;
wherein the code when executed in the determined remote server receiving the transmitted request for the artifact performs operations comprising:
determining the connection information for the remote server including the target application providing the artifact; and
using the determined connection information to forward the request for the artifact to the remote server including the target application.

6. The article of manufacture of claim 5, wherein the code when executed in the determined remote server further performs:
receiving the requested artifact from the remote server including the target application to which the request was forwarded; and
transmitting the requested artifact to the remote server.

7. The article of manufacture of claim 1, wherein the code implements an artifact loader client and an artifact loader server, where the artifact loader client receives requests for artifacts at target applications on remote servers, wherein the artifact loader client communicates the request for the artifact at the target application to an artifact loader server on the remote server that receives requests for artifacts at the target application in the remote server and accesses the artifacts from the target application to return to the artifact loader clients requesting the artifacts.

8. The article of manufacture of claim 7, wherein the artifact loader client receives the request for the artifact from an application executing in the server including the artifact loader client or the artifact loader server executing in the server receiving the request for the artifact from an artifact loader client executing in an external server.

9. The article of manufacture of claim 8, wherein the server, the remote server, and the common repository are designated in a cell in which the connection information in the common repository is shared among servers in the cell, and where the external server is not included in the cell.

10. A server in communication with remote servers over a network, wherein applications execute in the remote servers, and wherein a common repository is in communication with the network, comprising:
a local repository;
a server including an artifact loader client executed to perform operations, the operations comprising:
receiving a request for an artifact at a target application executing on one of the remote servers;
determining whether the local repository includes connection information on the remote server, wherein the connection information is used to communicate the request for the artifact to the remote server over the network;
accessing the connection information from the local repository in response to determining that the local repository includes the connection information for the remote server;
determining whether the common repository is available to provide the connection information for the remote server in response to determining that the local repository does not include the connection information for the remote server; and
communicating with the common repository over the network to access the connection information for the remote server in response to determining that the common repository is available to provide the connection information.

11. The system of claim 10, wherein the request includes a name of the target application, a type of the requested artifact, and a name of the requested artifact, and wherein the connection information indicates a network address and a port to use to communicate with the remote server.

12. The system of claim 10, wherein the common repository is available to provide the connection information if the server is designated in a cell including the common repository and the remote server including the target application.

13. The system of claim 12, wherein the server is not in the cell including the remote server and the common repository, wherein the artifact loader client operations further comprise:
transmitting the request for the artifact to a determined one of the remote servers in the cell including the remote server including the target application in response to determining that the server is not in the cell including the remote server, wherein the determined remote server receiving the transmitted request determines the connection information for the remote server including the target application providing the artifact, and wherein the determined remote server uses the determined connection information to forward the request for the artifact to the remote server including the target application.

14. The system of claim 10, wherein the artifact loader client communicates the request for the artifact at the target application to an artifact loader server on the remote server that receives requests for artifacts at the target application in the remote server and accesses the artifacts from the target application to return to the artifact loader clients requesting the artifacts.

15. A method, comprising:
receiving a request in a local server for an artifact at a target application executing on a remote server;
determining whether a local repository includes connection information on the remote server, wherein the connection information is used to communicate the request for the artifact to the remote server over a network;
accessing the connection information from the local repository in response to determining that the local repository includes the connection information for the remote server;
determining whether a common repository is available to provide the connection information for the remote server in response to determining that the local repository does not include the connection information for the remote server; and
communicating with the common repository over the network to access the connection information for the remote server in response to determining that the common repository is available to provide the connection information.

16. The method of claim 15, wherein the request includes a name of the target application, a type of the requested artifact, and a name of the requested artifact, and wherein the connection information indicates a network address and a port to use to communicate with the remote server.

17. The method of claim 15, wherein the common repository is available to provide the connection information if the local server is designated in a cell including the common repository and the remote server including the target application.

18. The method of claim 17, wherein the local server is not in the cell including the remote server and the common repository, further comprising:
transmitting, by the local server, the request for the artifact to a determined remote server in the cell including the remote server including the target application in response to determining that the local server is not in the cell including the remote server;
determining, by the determined remote server receiving the transmitted request, the connection information for the remote server including the target application providing the artifact; and
using, by the determined remote server, the determined connection information to forward the request for the artifact to the remote server including the target application.

19. The method of claim 16, wherein an artifact loader client at the local server receives requests for artifacts at target applications on remote servers, wherein the artifact loader client communicates the request for the artifact at the target application to an artifact loader server on the remote server that receives requests for artifacts at the target application in the remote server and accesses the artifacts from the target application to return to the artifact loader clients requesting the artifacts.

20. The method of claim 19, wherein the artifact loader client receives the request for the artifact from an application executing in the local server or an artifact loader server executing in the local server receiving the request for the artifact from an artifact loader client executing in an external server.
